(19) United States
(12) Patent Application Publication
(10) Pub. No.: US 2025/0145117 A1
(43) Pub. Date: May 8, 2025

(54) CYLINDRICAL ROTATING DEBRIS MANAGEMENT SYSTEM

(71) Applicant: International Truck Intellectual Property Company, LLC, Lisle, IL (US)

(72) Inventor: Robert M. Tourville, Aurora, IL (US)

(73) Assignee: International Truck Intellectual Property Company, LLC, Lisle, IL (US)

(21) Appl. No.: 18/387,559

(22) Filed: Nov. 7, 2023

(51) Int. Cl. B60S 1/52; B60S 1/04; B60S 1/54; B60S 1/56

(52) U.S. Cl. CPC B60S 1/52; B60S 1/0411; B60S 1/54; B60S 1/566

(57) ABSTRACT

A debris management system includes a cylindrical housing configured to rotate and adapted to contain at least one sensor disposed within an internal volume of the cylindrical housing and having a field of view through an exterior surface of the cylindrical housing. A solvent nozzle is disposed outside of the cylindrical housing and configured to spray solvent at the exterior surface of the cylindrical housing. A drying mechanism is disposed outside of the cylindrical housing and configured to dry the exterior surface.

### FIELD OF THE INVENTION

The present disclosure relates generally to a debris management system for cleaning debris blocking the field of view of vehicle mounted sensors, and more particularly to such a debris management system having a cylindrical rotating cover.

### BACKGROUND

Sensors are being disposed on surfaces of modern vehicles in ever increasing numbers. Such sensors are distributed all around a vehicle for collecting data on the vehicle surroundings in all directions for use in critical tasks, for example, including autonomous driving modes. It is crucial that such sensors function accurately without being fouled by debris blocking the field of view of the sensor. A need therefore exists for a robust and reliable cleaning system that can clean the field of view of vehicle mounted sensors in any driving environment. It would be useful if such a cleaning system could operate to clean the field of view of one or more sensors as needed.

### SUMMARY OF THE INVENTION

In one aspect of the invention, a debris management system comprises a cylindrical housing configured to rotate and adapted to contain at least one sensor disposed within an internal volume of the cylindrical housing and having a field of view through an exterior surface of the cylindrical housing. A solvent nozzle is disposed outside of the cylindrical housing and configured to spray solvent at the exterior surface of the cylindrical housing. A drying mechanism is disposed outside of the cylindrical housing and configured to dry the exterior surface.

In another aspect of the invention, a debris management system comprises a cylindrical housing having a circumferential surface configured to rotate around a longitudinal axis, the cylindrical housing adapted to contain at least one sensor disposed within an internal volume of the cylindrical housing and having a field of view through the circumferential surface of the cylindrical housing. A solvent nozzle is disposed outside of the cylindrical housing and configured to spray solvent at the circumferential surface of the cylindrical housing. A drying mechanism is disposed outside of the cylindrical housing and configured to dry the circumferential surface.

In a further aspect of the invention, a debris management system comprises a cylindrical housing having a circumferential surface configured to rotate around a longitudinal axis. At least one sensor is disposed within an internal volume of the cylindrical housing and having a field of view through the circumferential surface of the cylindrical housing. A solvent nozzle is disposed outside of the cylindrical housing and configured to spray solvent at the circumferential surface of the cylindrical housing. A drying mechanism is disposed outside of the cylindrical housing and configured to dry the circumferential surface.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 is a schematic front perspective view of an exemplary cylindrical housing according to an embodiment;

FIG. 2 is a schematic top plan view of the exemplary cylindrical housing of FIG. 1; and

FIG. 3 is a schematic diagram of an exemplary debris management system according to an embodiment.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

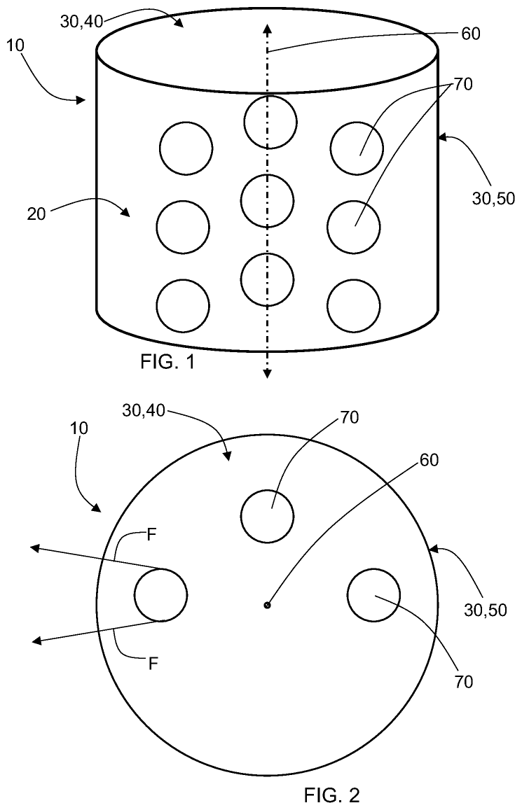

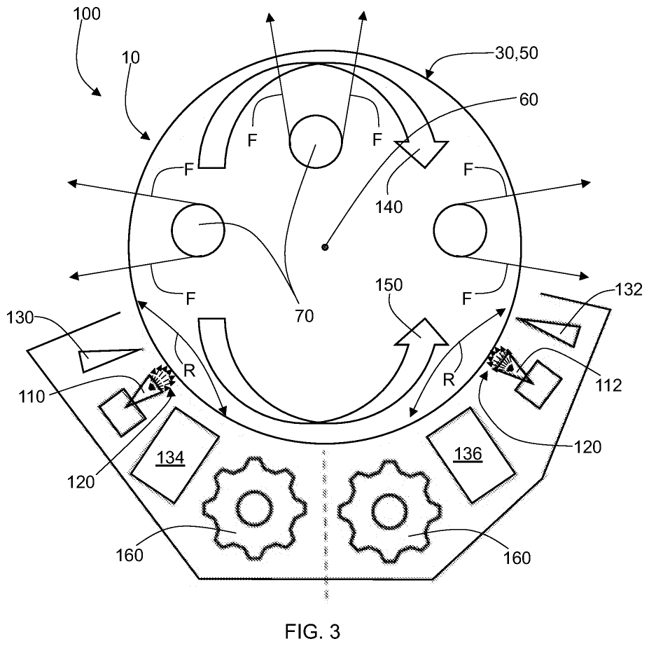

Referring to FIGS. 1 and 2, an exemplary embodiment of a cylindrical housing 10 is shown. The cylindrical housing 10 has an interior volume 20, and an exterior surface 30 that comprises top and bottom surfaces 40 and a circumferential surface 50 that extends between the top and bottom surfaces 40. In an embodiment the cylindrical housing 10 is configured to rotate around a longitudinal axis 60 disposed through a center of the top and bottom surfaces 40.

In an embodiment, the cylindrical housing 10 is adapted to contain at least one sensor 70 disposed within the internal volume 20 of the cylindrical housing 10 and having a field of view, for example illustrated by the arrows F in FIG. 3, where the field of view passes through the exterior surface 30, 50 of the cylindrical housing 10. In an embodiment, the at least one sensor 70 is selected from the group of sensors consisting of an optical sensor, a light direction and ranging (LIDAR) sensor, a radio detection and ranging (RADAR) sensor, an infrared sensor, and a sonic sensor. Without being held to theory, in all embodiments herein the cylindrical housing 10 is made from a material that is transparent to the field of view of the at least one sensor 70.

Referring to FIG. 3, an exemplary embodiment of a debris management system (DMS) 100 includes the cylindrical housing 10 adapted to contain the at least one sensor 70. In an embodiment, the DMS 100 comprises a solvent nozzle 110 disposed outside of the cylindrical housing 10 and configured to spray solvent, represented by the group of dashed arrows 120, at the exterior surface 30, 50 of the cylindrical housing 10. In an embodiment, the DMS 100 comprises a second solvent nozzle 112 disposed outside of the cylindrical housing 10 and configured to spray solvent 120 at the exterior surface 30, 50 of the cylindrical housing 10.

In an embodiment, the DMS 100 comprises a drying mechanism 130 disposed outside of the cylindrical housing 10 and configured to dry the exterior surface 30, 50. In another embodiment, the DMS 100 comprises a second drying mechanism 132 disposed outside of the cylindrical housing 10 and configured to dry the exterior surface 30, 50. In further embodiments, the DMS 100 comprises additional drying mechanisms 134, 136, each disposed outside of the cylindrical housing 10 on an opposite side of the solvent nozzles 110, 112, relative to the drying mechanisms 130, 132, respectively, and configured to dry the exterior surface 30, 50.

In an embodiment, each of the drying mechanisms 130, 132, 134, 136 is a stationary wiper 130, 132, 134, 136 disposed in contact with the exterior surface 30, 50. In another embodiment each of the drying mechanisms 130, 132, 134, 136 is a compressed air curtain 130, 132, 134, 136 directed at the exterior surface 30, 50. In other embodiments, each of the drying mechanisms 130, 132, 134, 136 is either a stationary wiper 130, 132, 134, 136 disposed in contact with the exterior surface 30, 50 or a compressed air curtain 130, 132, 134, 136 directed at the exterior surface 30, 50. In an embodiment, the solvent nozzles 130, 132 and the drying mechanisms 130, 132, 134, 136 are all disposed outside of the field of view, F, of the at least one sensor 70. Still referring to FIG. 3, in an embodiment, the cylindrical housing 10 is configured to rotate in a clockwise direction as viewed along the longitudinal axis 60 and as indicated by arrow 140, and in a counterclockwise direction as viewed along the longitudinal axis 60 and as indicated by arrow 150. In an embodiment, the cylindrical housing 10 is rotated by one or more motors 160 operationally connected to the cylindrical housing 10, for example via a geared connection to an axle (not shown) disposed along the longitudinal axis 60, or a geared connection to a ring gear (not shown) disposed around a base of the cylindrical housing 10, or via a belt (not shown) driven by the one or more motors 160 and looped around a pulley (not shown) disposed on a base of the cylindrical housing 10 or on an axle (not shown) disposed along the longitudinal axis 60, or via any other mechanism as known in the art for connecting the motive force of the one or more motors to the cylindrical housing 10.

In an embodiment, the DMS 100 is configured to operate in at least two operational modes. In a first operational mode, the DMS 100 operates to clean the exterior surface 30, 50 covering the one or more sensors 70 as needed or according to a predetermined schedule. In the first operational mode, when the cylindrical housing 10 rotates, one of the solvent nozzles 130, 132 sprays solvent or a cleaning agent of some sort 120 at a region, for example illustrated as the region R in FIG. 3, of the exterior surface 30, 50 outside of the field of view F of the at least one sensor 70. In this mode of operation, the cylindrical housing 10 executes an indexed rotation sufficient to move the region R to within the field of view F of the at least one sensor 70. As the cylindrical housing 10 rotates and is sprayed with the solvent 120, the drying mechanisms 130, 132, 134, 136 operate to wipe or blow off the solvent 120 and debris loosened or broken down by the solvent 120 so that when the indexed rotation of the cylindrical housing 10 stops, the region R is free of debris and disposed in the field of view F of the at least one sensor 70.

In a second mode of operation, the DMS 100 operates to clean the exterior surface 30, 50 covering the one or more sensors 70 continuously. In the second operational mode, the cylindrical housing 10 is configured to rotate continuously. In an embodiment, the continuous rotation of the cylindrical housing 10 is accompanied by operation of the drying mechanisms 130, 132, 134, 136, and would be beneficial during precipitation events to prevent precipitation build up on the exterior surface 30, 50.

In an embodiment, the cylindrical housing 10 protects the at least one sensor 70 housed within from damage due to environmental or other external factors. The cylindrical housing 10 can therefore be repaired or replaced as needed due to damage without any effect on the at least one sensor 70.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,” “around,” “substantially,” etc., mean plus or minus ten percent.

### INDUSTRIAL APPLICABILITY

A debris management system comprises a cylindrical housing configured to cover one or more sensors transparently to the sensors provide protection against environmental debris that could damage the sensors. The cylindrical housing includes components to clean and wipe or blow debris from the exterior surface. The system can be manufactured in industry for use on vehicles purchased by consumers.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

1. A debris management system comprising:
a cylindrical housing configured to rotate and containing at least one sensor disposed within an internal volume of the cylindrical housing and having a field of view through an exterior surface of the cylindrical housing;
a solvent nozzle disposed outside of the cylindrical housing and configured to spray solvent at the exterior surface of the cylindrical housing; and
a drying mechanism selected from the group consisting of a stationary wiper in contact with the exterior surface, and a compressed air curtain directed at the exterior surface disposed outside of the cylindrical housing and configured to dry the exterior surface.

2. The debris management system of claim 1, wherein the exterior surface is configured to rotate around a longitudinal axis.

3. (canceled)

4. The debris management system of claim 2, wherein the solvent nozzle and the drying mechanism are both disposed outside of the field of view of the at least one sensor.

5. The debris management system of claim 4, wherein the solvent nozzle sprays solvent at a region of the exterior surface outside of the field of view of the at least one sensor when the cylindrical housing executes an indexed rotation sufficient to move the region to within the field of view of the at least one sensor.

6. The debris management system of claim 4, wherein the cylindrical housing is configured to rotate continuously.

7. The debris management system of claim 2, wherein the cylindrical housing is configured to rotate in both clockwise and counterclockwise directions as viewed along the longitudinal axis.

8. (canceled)

9. A debris management system comprising:
a cylindrical housing having a circumferential surface configured to rotate around a longitudinal axis, the cylindrical housing containing at least one sensor disposed within an internal volume of the cylindrical housing the at least one sensor having a field of view through the circumferential surface of the cylindrical housing;
a solvent nozzle disposed outside of the cylindrical housing and configured to spray solvent at the circumferential surface of the cylindrical housing; and
a drying mechanism selected from the group consisting of a stationary wiper in contact with the circumferential surface, and a compressed air curtain directed at the circumferential surface disposed outside of the cylindrical housing and configured to dry the circumferential surface.

10. (canceled)

11. The debris management system of claim 9, wherein the solvent nozzle and the drying mechanism are both disposed outside of the field of view of the at least one sensor.

12. The debris management system of claim 11, wherein the solvent nozzle sprays solvent at a region of the circumferential surface outside of the field of view of the at least one sensor when the cylindrical housing executes an indexed rotation sufficient to move the region to within the field of view of the at least one sensor.

13. The debris management system of claim 11, wherein the cylindrical housing is configured to rotate continuously.

14. (canceled)

15. A debris management system comprising:
a cylindrical housing having a circumferential surface configured to rotate around a longitudinal axis;
at least one sensor disposed within an internal volume of the cylindrical housing and having a field of view through the circumferential surface of the cylindrical housing;
a solvent nozzle disposed outside of the cylindrical housing and configured to spray solvent at the circumferential surface of the cylindrical housing; and
a drying mechanism selected from the group consisting of a stationary wiper in contact with the circumferential surface, and a compressed air curtain directed at the circumferential surface disposed outside of the cylindrical housing and configured to dry the circumferential surface.

16. (canceled)

17. The debris management system of claim 15, wherein the solvent nozzle and the drying mechanism are both disposed outside of the field of view of the at least one sensor.

18. The debris management system of claim 17, wherein the solvent nozzle sprays solvent at a region of the circumferential surface outside of the field of view of the at least one sensor when the cylindrical housing executes an indexed rotation sufficient to move the region to within the field of view of the at least one sensor.

19. The debris management system of claim 17, wherein the cylindrical housing is configured to rotate continuously.
